(19) United States
(12) Patent Application Publication
(10) Pub. No.: US 2004/0061591 A1
(43) Pub. Date: Apr. 1, 2004

(54) Remote code authorization for access control systems

(76) Inventor: Rudor M. Teich, West Orange, NJ (US)

Correspondence Address: Michael I. Rackman, Gottlieb, Rackman & Reisman, P.C., 8th Floor, 270 Madison Avenue, New York, NY, 10016-0601, US

(21) Appl. No.: 10/445,633

(22) Filed: May 23, 2003

Related U.S. Application Data
(60) Provisional application No. 60/413,760, filed on Sep. 27, 2002.

(51) Int. Cl. H04Q 1/00; G05B 19/00; H04B 1/00; G05B 23/00

(52) U.S. Cl. 340/5.24; 340/5.64

(57) ABSTRACT

A simple, secure and cost effective method to program authorized transmitters into the memory of a controller, such as that in a garage door opener, which does not require a learn switch. An already-authorized transmitter is used to prime the receiver to add a new transmitter identification code to its list. The sequence is to press the button of any transmitter that is already recognized by the controller, within a short time window (e.g., 3 seconds) to press the button of the new transmitter that is to be added, and within another short time window (e.g., 3 seconds) press again the button of the transmitter used in the first step.

This application claims the benefit of United States Provisional application No. 60/413,760 filed on Sep. 27, 2002.

### BACKGROUND OF THE INVENTION

This invention relates to remote-controlled moveable barriers. Examples of such systems are gate openers and garage door openers. Throughout this application, the term Garage Door Opener (GDO) will be used to include any such mechanized barrier-control system. However, the invention may be applied to any application where there is a need to uniquely identify and link two or more devices that are in communication with each other. Examples of such non-GDO systems are wireless alarms systems, home light controls and, in general, addressable networks. The description that follows is by way of a GDO example, but the invention is more generally applicable.

Garage Door Openers have gained popularity and market acceptance due to the convenience, security and safety that they offer. A remote-controlled GDO comprises a motor-controller and at least one remote transmitter. The transmitter is used to open or close the barrier from a distance, e.g., from a user's car. The transmitter thus acts as an electronic key to unlock and open the barrier. Transmitters are also used to provide operational information to the GDO.

The security requirements of a GDO system dictate that the GDO respond only to commands from an authorized source. This is achieved by maintaining a list of the authorized transmitters' identification (ID) codes in the GDO's controller.

In operation, a transmitter sends out a code that includes the transmitter's ID, as well as a command for the GDO controller, e.g., open the barrier. The controller receives the signal and decodes it. It also compares the ID of the transmission with the IDs that have been authorized. If it finds a match, it will respond to honor the command that it received.

There are two fundamental methods for storing an ID in a transmitter. One method involves setting jumpers or switches on the transmitter. An example of a system which utilizes switches to set the code in the transmitter is described in Pat. No. 3,906,348 to Willmott.

The second method stores the ID number in a non-volatile semiconductor memory in the transmitter. An example of a system where the ID of the transmitter is stored in a semiconductor memory is described in Pat. No. 4,750,118 to Heitschel et al.

In addition to storing an ID in the transmitter, there is a similar requirement to store authorized ID codes in the controller. Here, too, the code can be stored by switches (Pat. No. 3,906,348), or in semiconductor memory (Pat. No. 4,750,118). The two types of ID storage can be mixed—for example, storing the ID code in the transmitter using switches, and storing the authorized code(s) in the controller in a semiconductor non-volatile memory.

The current state of the art of garage door openers has evolved to accommodate a number of transmitters, where each can control the same barrier. For example, a family with two cars and a two-car garage can be provided with two transmitters so that each car can be equipped with its own transmitter. This allows the two drivers to open the garage door from the comfort and safety of their individual cars. Such a system is described in U.S. Pat. No. 4,750,118. It is commercially available from The Chamberlain Group of Elmhurst, IL, and others. In controllers that support a multitude of transmitters, the most common method of storing the transmitter ID list is by the use of semiconductor memory. In the current generation of GDO products, each transmitter is assigned a unique ID code, which is programmed into it at the factory. Although only a finite number of code combinations is available, the number of these combinations runs into the millions and it is thus statistically unlikely that two transmitters will have the same ID code or address. There is no provision for changing the ID code of a transmitter in the field. An alternate method by which transmitters are reprogrammed with every attempt to teach a code to the controller is described in copending patent application Ser. No. 10/054,305 filed on Jan. 22, 2002.

The industry has adopted an encryption concept where the transmitter sends an apparent ID code that changes with each transmission. This copy-resistant code technique is referred to as “rolling,” “roaming” or “hopping” code. With rolling codes, only the appearance of the address changes with each activation. The underlying ID is traceable through encryption techniques to the factory-set address. For the purpose of this description, the transmitter address code can be said to be fixed. An example of such a rolling code system is described in U.S. Pat. No. 6,049,289 to Waggamon et al.

The process by which a transmitter's ID is added to the authorized list in the GDO is called learning. The most common learning process involves two steps on the part of the user:

(1) The GDO controller is placed in a learning mode using a switch on the controller.

(2) The transmitter is activated in operating proximity to the GDO, the transmitter sending a normal operating command packet, identical to the command used to operate the barrier.

The controller then adds the ID of the transmitter to its list and, if necessary, the ID of an older-entry is deleted from the list to make room for the new addition. This process links the addition of a new code in the GDO with the deletion of an older code. The need to delete an ID when a new one is added is imposed by the reality of having a limited space in which to store transmitter IDs. The need to restrict the number of transmitter codes in the list is also mandated by the time it takes to search the list for a match; the longer the list, the longer the delay between the transmission and the resultant barrier activation.

In memory systems using semiconductor storage, the IDs of the individual transmitters in the authorized list are not usually accessible for modification. This limitation is mandated by the cost of adding a display to allow access to an individual ID in the list and to identify its owner. An early method proposed in U.S. Pat. No. 4,750,118, where a selector switch assigns specific memory locations for the storage and retrieval of IDs in the list, did not gain favor in the industry, as it required keeping records of which transmitter ID was stored in each location. Subsequently, a sequential memory approach was adopted.

To teach a GDO a new code, the GDO is usually placed in a learn mode by operating an appropriate switch or button on the GDO. Then the transmitter whose code is to be learned is operated. When the code is received while the GDO is in the learn mode, the code is added to the GDO's list, displacing the earliest stored code in a FIFO memory if necessary. The reason that a button on the GDO must be operated to place the GDO in the learn mode is that learning of new codes has to be authorized, and it is assumed that anyone who has physical access to the GDO is authorized to control storage of new codes.

The limitation of all the current systems described above is that a new code can be taught to the controller by anyone who has physical access to the learn switch on the controller. In most garage doors applications, it is assumed that the controller is located inside the protected and locked environment of a garage, and thus access to the learn switch is possible only when the garage door is open. There are applications, however, where it is not possible or desirable or economically feasible to restrict access to the learn switch through mechanical obstruction. One such application is a self-contained barrier system described in copending patent application Ser. No. 02/20626. In the self-contained barrier system, the controller is mounted inside a weatherproof assembly. Access to a learn switch can only be restricted by the use of a mechanical lock or the use of a key-operated switch. Adding such a mechanical lock is not desirable, as the lock adds cost and complexity to the structure. And locks are not reliable under the conditions of flooding, rain, snow and ice that are encountered in the environment of road-mounted barrier applications.

It is an object of this invention to provide a simple, secure and cost effective method to program authorized transmitters into the memory of a controller, such as that in a GDO, which does not require a learn switch.

### SUMMARY OF THE INVENTION

In my invention, an already-authorized transmitter is used to prime the receiver to add a new transmitter identification code to its authorized list. The sequence is as follows:

1. The user presses the button of any transmitter that is already recognized by the controller.

2. Within a short time window (e.g., 3 seconds), the user presses the button of the new transmitter that is to be added.

3. Within a second short time window (e.g., 3 seconds), the user presses again the button of the transmitter used in the first step.

The controller, upon receiving a new ID code immediately after an old ID code that it recognizes, adds the new ID code to its list. The sequence can be simplified by omitting the third step. However, the third step is advantageous in that it assures that a new transmitter will not be added surreptitiously “forged”) by a person standing close by and activating a new transmitter immediately following activation of the controller by the authorized user. If the third step is employed in the method of my invention, the new ID code is not registered by the controller if an already authorized ID code is not sent after the new code as well as before it.

An exception to all of this is the case where there are no ID codes in the authorized list in the GDO controller. This is the GDO condition when it leaves the factory. The controller registers the first ID code it receives when there are no transmitters in the authorized list. The first transmitter that is used once the GDO is installed and powered will be placed immediately in the list of recognized codes in the GDO (at which time it will be the only one).

If a new transmitter needs to be added to the GDO without the presence of an authorized transmitter (e.g., if there is only one authorized transmitter and it is lost or broken), the GDO memory needs to be purged of all recognized codes. This is because there is no authorized transmitter that can be used to set up the controller for immediate receipt of a new ID code to be registered. By purging the list, for example, by a reboot, the controller will be in the state in which it left the factory and it will register the first ID code that is transmitted to it. Rebooting may require some disassembly of the controller to access and short a couple of test points on the controller printed circuit board, as is known in the art. Alternatively, but at somewhat increased cost, a reboot button can be provided instead of the shorting pin. In either case, access to the reboot mechanism should require disassembly of the controller as the inconvenience of disassembly is likely to discourage forging attempts by unauthorized persons.

### BRIEF DESCRIPTION OF THE DRAWINGS

Further objects, features and advantages of the invention will become apparent upon consideration of the following detailed description in conjunction with the drawing, in which:

FIG. 1 is a block diagram of a remote-controlled GDO with a remote transmitter and a motor controller with an integrated RF receiver;

FIG. 2 is a flow chart of the processing in the receiver when a transmitted code is received; and

FIG. 3 is the flow chart of a boot routine used in the receiver.

### DETAILED DESCRIPTION

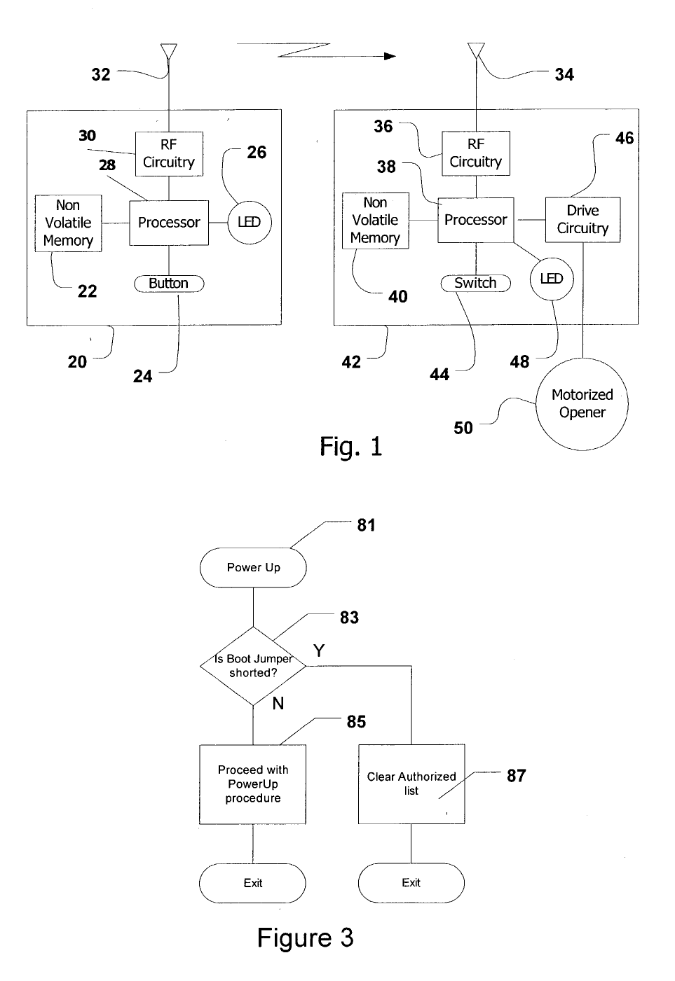

FIG. 1 shows the main elements in a remote-control system for a moveable barrier. A controller 42 is provided with drive circuitry 46 that can directly power a barrier opener such as a motorized garage door opener 50. The drive circuitry 46 is in turn controlled by a processor 38. The processor is a microprocessor in FIG. 1, but it can be a custom integrated circuit. The processor receives suitable RF signals from RF circuitry 36, which receives them via antenna 34. Memory 40, in addition to containing some or all elements of the program for processor 38, stores the list of authorized transmitter codes. The processor compares a received code against this list. Memory 40 may be an integral part of processor 38 or it may be a separate component.

Switch 44 is the boot command input that is read by the controller. LED 48 is provided for operational feedback and diagnostics. The controller remains continuously powered (unless for some reason the power is turned off). The reboot switch is activated by the user when it is desired to delete the authorized list, as will become apparent when the detailed sequencing is described.

The transmitter 20 comprises a processor 28, an RF transmitter 30 and associated antenna 32. The processor can be a microprocessor or a custom integrated circuit. Non-volatile memory 22 holds the unique ID of the transmitter. The transmitter, which is battery operated, is usually off. Pressing button 24 wakes up the processor 28. In the normal operating mode, the processor proceeds with sending an RF packet that is associated with the desired function of the button 24. LED 28 lights up to indicate transmission of an RF packet. At the completion of the transmission, the processor turns the circuitry back off.

In the illustrative transmitter, one button is used to achieve all the required functions of operating and teaching the GDO controller. However, nothing in this description should be construed as limiting the invention to such a single-button transmission. The invention encompasses transmitters with a multitude of buttons as well. For example, separate buttons may be provided for sending an “open” command, a “stop” command and a “close” command to the controller. In the preferred embodiment of the transmitter, a single button is used to implement all the above commands. (As is known in the art, a command may mean different things depending on the state of the door being operated - a single command may mean “open” if the door is closed, “close” if the door is open, and “stop” if the door is in motion.)

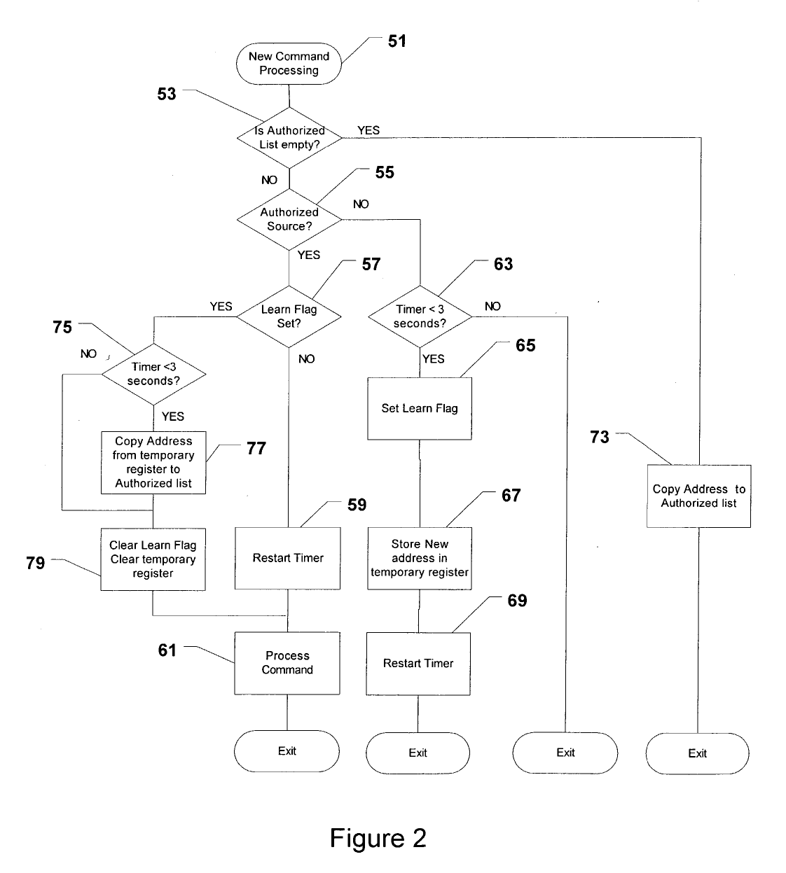

FIG. 2 shows a simplified flow chart for the processing of RF signals in the controller. The controller processes only command signals that satisfy a packet structure. Step 51 represents verification that a command in the proper form has been received. In step 53 the system first determines if the authorized ID list is empty. If it is, either because the controller arrived from the factory with the usual empty list or the list was purged by the user, in step 73 the received ID code (or “address”) of the transmitter is added and stored in the authorized list.

In almost all cases, however, the list will not be empty and the answer to test 53 is no. In step 55 the received address is compared with those stored in the authorized ID list in the memory 40. If the received ID code is not in the authorized list (the answer to test 55 is no), then the transmitter that sent the code is either one whose ID is to be added to the list, or it is someone else's transmitter whose ID should not be registered or responded to. As will become apparent, if a new code is to be registered (immediately after prior priming by a code stored on the list), then a three-second timer will be turned on. In step 63 the system checks if the timer is on. If it is not, then the received ID is not to be stored; it is ignored.

As will be described, the Learn flag is set when an authorized code is received followed within three seconds by a code that is not on the list. The Learn flag indicates that the new code is to be “learned” (stored on the list), but only if an authorized code is received within three seconds of the new code to verify that the new code is not some stray or the result of an attempt to obtain improper access to the controller. If the received ID code is not in the authorized list (the answer to test 55 is no) and the answer to the question in step 63 is yes (the three-second timer is on), then it means that an authorized code must have been previously transmitted not only to control some operating function but also to prime the controller to store the new code in the authorized list. In step 65 the Learn flag is set, and in step 67 the new ID is stored in a temporary register. The three-second timer is started in step 69. If within the next three seconds an authorized ID code is received, the ID code just stored in the temporary register will be transferred to and permanently stored in the list.

If the list is not empty (step 53) and the received code is authorized (step 55), then (a) the transmitter may have been operated with no intent for the controller to learn a new code, or (b) the transmitter may have been operated as the first step in the three-step sequence for registering a new code, or (c) the transmitter may have been operated as the third confirming step in the three-step sequence for registering a new code. In all three cases, the Learn flag is examined in step 57. If it is set, case (c) applies since a previously received new code set the flag after a first transmission of an authorized code. But the code is to be learned only if the confirming authorized code is received within three seconds of the new code. Since the new code also caused the timer to be restarted in step 69, the timer is checked in step 75. If three seconds have not gone by, in step 77 the temporarily stored ID code is added to the authorized list. The Learn flag is cleared since it is no longer needed, as is the temporary register since the code has already been stored permanently. Finally, the command that was transmitted is processed in step 61.

If in step 75 it is determined that the timer is not running, i.e., more than three seconds have gone by since the learn flag was set, then we have case (a). A new code was received within three seconds of an authorized code, which caused the Learn flag to be set, but it was not followed by another authorized code within three seconds. Perhaps the new code was sent unintentionally or it was transmitted by a neighbor's transmitter. Perhaps the authorized user changed his mind and no longer wants to register the new code. Whatever the reason, the receipt of the authorized code is simply treated as an ordinary operation, i.e., step 77 is skipped. The code that was stored temporarily is not transferred to the list. Instead, it and the Learn flag are cleared, and the command is processed in the usual way.

Case (b) is where the authorized code is the first in the three-step sequence for storing a new code in the list. The answer to test 57 in this case is negative. In step 59 the timer is started in preparation for the test in step 63 to be performed when the new code is received within three seconds. The command is processed and the cycle is completed. This same sequence is followed when a transmitter is operated just once to control a GDO function that has nothing to do with storing a new code in the controller.

FIG. 3 is a simplified flow chart of a boot sequence. If all authorized transmitters are lost, then the code for a new one cannot be entered. This is because a new code can be entered only if the list is empty or if the new code is preceded by an authorized code. What is done in this case is to trigger a boot sequence in which the entire list is erased (so that the new code can be entered into an empty list in the usual manner). All that must be done is to tell the processor that a boot sequence is required. Typically, a boot jumper (not shown) can be shorted, or a switch 44 on the controller's printed circuit board can be operated, etc., as is known in the art. As shown in FIG. 3, the boot procedure is started with the removal of power to the controller and the shorting of switch 44. When power is reapplied to the controller in step 81, the boot routine checks in step 83 whether the switch 44 is shorted. If it is not, the usual power-up procedure is followed. But if the switch or jumper is shorted, then in step 87 the entire list is erased. This allows a new code to be entered simply by transmitting it to the receiver.

Although the invention has been described with reference to a particular embodiment, it is to be understood that this embodiment is merely illustrative of the application of the principles of the invention. For example, the timer is not necessary. What is important is that an already authorized transmitter prime the controller (receiver) to register a new code if one is transmitted. A simple way to do this is to have the new code arrive shortly after the authorized code, but the time can vary. Also, instead of having two separate three-second intervals, it is possible simply to require all three codes (old, new, old) to be received within a set time interval. It is even possible to transmit the new code before an authorized code and to have the authorized code control registering of the previously sent new code, provided the codes are associated with each other, e.g., they are received in close time proximity, so that the receiver knows that the authorized code is the authority for storing the previously sent new code. Thus it is to be understood that numerous modifications may be made in the illustrative embodiment of the invention and other arrangements may be devised without departing from the spirit and scope of the invention.

What I claim is:

1. A remote control system having a receiver and one or more transmitters, each transmitter transmitting a respective identification code and the receiver having a list of identification codes associated with authorized transmitters, the receiver being operable to compare a received identification code to the codes on its list, the improvement by which the receiver is primed to add to its list a received new identification code upon prior receipt of an identification code that is already on its list.

2. A remote control system in accordance with claim 1 wherein a received new identification code is added to the receiver list only if it is received within a set time interval after the receiver is first primed to add a received new identification code to its list.

3. A remote control system in accordance with claim 2 wherein a received new identification code is added to the receiver list only if after its receipt the receiver receives an identification code that was previously on its list.

4. A remote control system in accordance with claim 2 wherein if the receiver list is empty then a received new identification code is added to the list even without the receiver being primed by an identification code that was previously on the list.

5. A remote control system in accordance with claim 1 wherein a received new identification code is added to the receiver list only if after its receipt the receiver receives an identification code that was previously on its list.

6. A remote control system in accordance with claim 5 wherein a received new identification code is added to the receiver list only if it and the subsequent identification code that was previously on its list are both received within a set time interval following receipt of the identification code that primed the receiver to add a new identification code to its list.

7. A remote control system in accordance with claim 1 wherein if the receiver list is empty then a received new identification code is added to the list even without the receiver being primed by an identification code that was previously on the list.

8. A remote control system comprising a receiver and one or more transmitters, each transmitter transmitting a respective identification code and the receiver having a list of identification codes associated with authorized transmitters, the receiver including means operable to compare a received identification code to the codes on its list, and means for controlling the receiver to add to its list a received new identification code upon associated receipt of an identification code that is already on its list.

9. A remote control system in accordance with claim 8 wherein a received new identification code is added to the receiver list only if it is received within a set time interval of receipt of an identification code that is already on its list.

10. A remote control system in accordance with claim 9 wherein a received new identification code is added to the receiver list only if after its receipt the receiver receives an identification code that was previously on its list.

11. A remote control system in accordance with claim 9 wherein if the receiver list is empty then a received new identification code is added to the list even without receipt of an identification code that was previously on the list.

12. A remote control system in accordance with claim 8 wherein a received new identification code is added to the receiver list only if after its receipt the receiver receives an identification code that was previously on its list.

13. A remote control system in accordance with claim 12 wherein a received new identification code is added to the receiver list only if it and an identification code that was previously on its list are both received within a set time interval following receipt of an identification code that controlled the receiver to add a new identification code to its list.

14. A remote control system in accordance with claim 8 wherein if the receiver list is empty then a received new identification code is added to the list even without receipt of an identification code that was previously on the list.

15. A method of operating a remote control system having a receiver and one or more transmitters, each transmitter transmitting a respective identification code and the receiver having a list of identification codes associated with authorized transmitters, the receiver being operable to compare a received identification code to the codes on its list, the improvement by which the receiver adds to its list a received new identification code if it is accompanied by receipt of an identification code that is already on its list.

16. A method of operating a remote control system in accordance with claim 15 wherein a received new identification code is added to the receiver list only if it is received within a set time interval of the receipt of an identification code already on the receiver list.

17. A method of operating a remote control system in accordance with claim 16 wherein a received new identification code is added to the receiver list only if after its receipt the receiver receives an identification code that was already on its list.

18. A method of operating a remote control system in accordance with claim 16 wherein if the receiver list is empty then a received new identification code is added to the list even without receipt of an identification code that was already on the list.

19. A method of operating a remote control system in accordance with claim 15 wherein a received new identification code is added to the receiver list only if after its receipt the receiver receives an identification code that was already on its list.

20. A method of operating a remote control system in accordance with claim 19 wherein a received new identification code is added to the receiver list only if it and a subsequent identification code that was already on the receiver list are both received within a set time interval following receipt of an identification code that was already on the receiver list.

21. A method of operating a remote control system in accordance with claim 15 wherein if the receiver list is empty then a received new identification code is added to the list even without receipt of an identification code that was already on the list.

22. A method of operating a remote control system comprising the steps of providing a receiver and one or more transmitters, each transmitter transmitting a respective identification code and the receiver having a list of identification codes associated with authorized transmitters, the receiver operating to compare a received identification code to the codes on its list, and priming the receiver to add to its list a received new identification code upon receipt of an identification code that is already on its list.

23. A method in accordance with claim 22 wherein a received new identification code is added to the receiver list only if it is received within a set time interval after the receiver is first primed to add a received new identification code to its list.

24. A method in accordance with claim 23 wherein a received new identification code is added to the receiver list only if after its receipt the receiver receives an identification code that was previously on its list.

25. A method in accordance with claim 23 wherein if the receiver list is empty then a received new identification code is added to the list even without the receiver being primed by an identification code that was previously on the list.

26. A method in accordance with claim 8 wherein a received new identification code is added to the receiver list only if after its receipt the receiver receives an identification code that was previously on its list.

27. A remote control system in accordance with claim 26 wherein a received new identification code is added to the receiver list only if it and the subsequent identification code that was previously on its list are both received within a set time interval following receipt of the identification code that primed the receiver to add a new identification code to its list.

28. A method in accordance with claim 22 wherein if the receiver list is empty then a received new identification code is added to the list even without the receiver being primed by an identification code that was previously on the list.
